(19) United States
(12) Patent Application Publication
(10) Pub. No.: US 2025/0267033 A1
(43) Pub. Date: Aug. 21, 2025

(54) INTERFACE MODULE FOR A SUBSCRIBER STATION OF A SERIAL BUS SYSTEM AND METHOD FOR TRANSMITTING A MESSAGE IN A SERIAL BUS SYSTEM

(71) Applicant: Robert Bosch GmbH, Stuttgart (DE)

(72) Inventors: Olaf Kleinwegen, PLIEZHAUSEN (DE); Steffen Walker, Reutlingen (DE)

(21) Appl. No.: 18/857,682

(22) PCT Filed: Jun. 26, 2023
(86) PCT No.: PCT/EP2023/067277

§ 371 Date: Oct. 17, 2024

(30) Foreign Application Priority Data
Aug. 15, 2022 (DE) 10 2022 208 457.8

(51) Int. Cl. H04L 12/40; H04L 25/02; H04L 25/49

(52) U.S. Cl. CPC H04L 12/40013; H04L 12/4013; H04L 25/0272; H04L 25/4902; H04L 2012/40215

(57) ABSTRACT

An interface module for a subscriber station of a serial bus system. A transmitting module transmits a digital transmission signal as an analog differential signal onto a bus of the bus system to transmit a message to at least one other subscriber station of the bus system. Bits in the digital transmission signal have a longer bit duration in a first communication phase than in a second. The interface module has a time measuring block for measuring, with a predetermined timing clock, a predetermined time in the digital transmission signal, which is designed to stop its measurement if the measured value of the time measuring block has reached a predetermined limit value, and an evaluation block for evaluating the measured value of the time measuring block to set the transmitting module for operation in the first communication phase or in the second communication phase based on the evaluation result.

### FIELD

The present invention relates to an interface module for a subscriber station of a serial bus system and to a method for transmitting a message in a serial bus system, which is in particular a CAN XL bus system.

### BACKGROUND INFORMATION

Serial bus systems, in particular a CAN bus system, are used for message or data transmission in technical systems. For example, a serial bus system can make communication possible between sensors and control units in a vehicle or a technical production plant, etc.

In a CAN bus system, messages are transmitted using the CAN and/or CAN FD protocol, as described in the standard ISO-11898-1:2015 as CAN protocol specification with CAN FD. With CAN FD, transmission on the bus switches back and forth between a slow operating mode in a first communication phase (arbitration phase) and a fast operating mode in a second communication phase (data phase). Most manufacturers use CAN FD with a 500 kbit/s arbitration bit rate and a 2 Mbit/s data bit rate in the vehicle.

Successor bus systems for CAN FD, such as CAN SiC and CAN XL, are compatible with CAN FD and are designed for even higher data rates in the second communication phase. With CAN SiC according to the CiA601-4 standard of the CAN in Automation (CiA) organization, a data rate of about 5 to 8 Mbit/s can be achieved in the second communication phase. In the case of CAN XL according to the CiA601-3 standard, a data rate of >10 Mbit/s is required in the second communication phase. In addition to pure data transport via the CAN bus, CAN XL is also intended to support other functions, such as functional safety, data security and quality of service (QOS). These are elementary properties which are required, for example, in an autonomously driving vehicle.

In the CAN XL, CAN FD and CAN SiC bus systems, in the second communication phase the data are thus sent to the bus at a higher data rate than in the first communication phase. In CAN XL, a bit of a transmission signal in the second communication phase not only has a shorter bit duration or bit time or temporal length than in the first communication phase, but is usually also sent with a different physical layer to the bus and received with a different receiving threshold than in the first communication phase. Consequently, with CAN XL, the bus levels of the bus signals CAN_H, CAN_L for the first communication phase can differ from the bus levels of the second communication phase. In CAN XL, the type of communication in the second communication phase is also called FAST MODE. The physical layer corresponds to the bit transmission layer or layer 1 of the conventional OSI model (Open Systems Interconnection Model).

Communication on the bus that is as trouble-free as possible can therefore only take place when CAN XL subscriber stations of the bus system use a transmitting/receiving device that detects and carries out the switching between the two communication phases in a message to be sent to or received from the bus as error-free as possible and converts the level of a transmission signal correctly for the bus. The transmitting/receiving device can also be referred to as a CAN transceiver or CAN FD transceiver, etc.

For this reason, a transmitting/receiving device (transceiver) is required for CAN XL, which ensures communication that is as error-free as possible for all operating phases of communication on the bus.

### SUMMARY

It is an object of the present invention to provide an interface module for a subscriber station for a serial bus system and a method for transmitting a message in a serial bus system which solve the aforementioned problems. In particular, an interface module for a subscriber station of a serial bus system and a method for transmitting a message in a serial bus system should make possible a reliable and uncomplicated creation/generation of bus signals, even when the physical layer is switched between two communication phases during communication on the bus.

The object may be achieved by an interface module for a subscriber station of a serial bus system having certain features of the present invention. In the bus system, a transmitting module is designed to transmit a digital transmission signal as an analog differential signal to a bus of the bus system in order to transmit a message to at least one other subscriber station of the bus system, wherein bits in the digital transmission signal have a longer bit duration in a first communication phase than in a second communication phase of the transmission signal. According to an example embodiment of the present invention, the interface module has at least one time measuring block for measuring, with a predetermined timing, a predetermined time in the digital transmission signal, wherein the at least one time measuring block is designed to stop its measurement when the measured value of the at least one time measuring block has reached a predetermined limit value, and an evaluation block for evaluating the measured value of the at least one time measuring block at the end of the predetermined time in order to set the transmitting module for operation in the first communication phase or for operation in the second communication phase on the basis of the evaluation result.

The described interface module of the present invention is designed in such a way that a reliable, precise and nevertheless uncomplicated creation of a transmission signal for bus signals takes place during operation of the bus system. The transmission signal of the subscriber station can indicate how the operating mode for the transmitting module is to be preselected or set in order to correctly switch within a message between two communication phases for communication on the bus.

In addition, the described interface module of the present invention is designed in such a way that the bus signals are reliably and readily detected during operation of the bus system. All this applies in particular to such communication in which the physical layer is switched between two communication phases for communication on the bus.

The described interface module of the present invention may ensure very low-error and therefore largely interference-free communication, in particular in accordance with the CiA610-3 standard of CAN XL, between subscriber stations of the bus system. Additional advantages are explained in more detail in the description of the figures.

Furthermore, the described interface module of the present invention also enables the functionality for using different receiving thresholds for arbitration and data phase. Not only is communication in the bus system between other subscriber stations realized at higher bit rates but also the transmittable bit rate is not reduced by errors in the communication.

Advantageous further embodiments of the interface module are disclosed herein.

According to an example embodiment of the present invention, the evaluation block may be designed to switch the transmitting module to a first operating mode for the first communication phase for transmitting on the basis of the evaluation result or to switch the transmitting module to a second operating mode or third operating mode for the second communication phase for transmitting.

In one embodiment variant of the present invention, the at least one time measuring block can have at least four time measuring blocks, wherein the evaluation block is designed to evaluate the measured value of the at least four time measuring blocks at the end of the predetermined time in order to decode a pulse-width-modulated symbol of the transmission signal by evaluating the measured values of the at least four time measuring blocks in order to output a pulse-width-demodulated transmission signal to the transmitting module.

The interface module described above can also have a switching block for outputting an oscillating signal for specifying the predetermined timing clock with which all time measuring blocks intermittently carry out their measurement.

In one embodiment variant of the present invention, a first time measuring block is designed to restart the measurement with each edge of the transmission signal and to stop the measurement when the measured value of the first time measuring block has reached a predetermined limit value, wherein the evaluation block is designed to preselect the second operating mode for the transmitting module for the second communication phase when the measured value of the first time measuring block corresponds to a first predetermined time.

In this case, according to an example embodiment of the present invention, a second time measuring block can be designed to start the measurement with each rising edge of the transmission signal and to measure until the next rising edge of the transmission signal until the predetermined limit value is exceeded, wherein a third time measuring block is designed to start the measurement with each falling edge of the transmission signal and to measure until the next falling edge of the transmission signal until the predetermined limit value is exceeded, and wherein the evaluation block is designed to switch the transmitting module for the second communication phase to the second operating mode if the evaluation of the measurement result of the second and third time measuring blocks shows that in the transmission signal the distance between a rising edge and a falling edge or the distance between a falling edge and a rising edge is equal to a second predetermined time, which is the bit duration of bits of the second communication phase, and which is shorter than the first predetermined time.

In addition, according to an example embodiment of the present invention, a fourth time measuring block can be designed to start the measurement with each rising edge of the transmission signal and to measure until the next falling edge of the transmission signal until the predetermined limit value is exceeded, wherein a fifth time measuring block is designed to start the measurement with each falling edge of the transmission signal and to measure until the next rising edge of the transmission signal until the predetermined limit value is exceeded, and wherein the evaluation block is designed to compare the measurement of the second and fourth time measuring blocks with each other and to compare the measurement of the third and fifth time measuring blocks with each other, and to output a pulse-width-demodulated transmission signal to the transmitting module on the basis of the comparison results.

According to one exemplary embodiment of the present invention, the at least one time measuring block is a counter. In this case, at least two time measuring blocks of the at least one time measuring block can be designed to stop counting at a count value which corresponds to the symbol time period for a PWM symbol of a pulse-width-modulated signal, wherein the evaluation block is designed to evaluate the value of the PWM symbol of the pulse-width-modulated signal at the end of a PWM symbol using the at least one time measuring block and to output a level for the pulse-width-demodulated transmission signal to the transmitting module using the evaluation result.

According to one exemplary embodiment of the present invention, the at least one time measuring block is designed as a capacitor with a voltage measuring device for measuring the voltage at the capacitor, wherein at least one switchable constant-current source is provided as a switching block which is designed to switch the at least one constant-current source in order to charge the capacitor over time, and wherein the at least one time measuring block is designed to stop the charging of the at least one capacitor at a predetermined limit voltage value which corresponds to the predetermined time. The evaluation block can be designed to evaluate the voltage value of at least one time measuring block.

The interface module of the present invention described above can be part of a transmitting/receiving device which also has a transmitting module for transmitting a digital transmission signal as an analog differential signal to a bus of the bus system in order to transmit a message to at least one other subscriber station of the bus system, and also has a receiving module for receiving signals from the bus and for generating a digital reception signal from the analog differential signal.

The transmitting module of the present invention can be designed to generate the analog differential signals in the first communication phase of the message with a different physical layer than in the second communication phase.

The transmitting/receiving device described above can be part of a subscriber station for a serial bus system. The subscriber station can also be a communication control device for controlling communication in the bus system and for generating a digital transmission signal as the basis for the digital pulse-width-modulated transmission signal for the interface module.

Optionally, the subscriber station is designed for communication in a bus system in which an exclusive, collision-free access of a subscriber station to the bus of the bus system is guaranteed at least temporarily.

The aforementioned object may further be achieved by a method for transmitting a message in a serial bus system having features of the present invention. According to an example embodiment of the present invention, the method is carried out using an interface module for a subscriber station of a serial bus system, wherein the subscriber station has a transmitting module and wherein the interface module has at least one time measuring block and an evaluation block, and wherein the method comprises the steps of measuring, using the at least one time measuring block and using a predetermined timing clock, a predetermined time in the digital transmission signal, wherein the at least one time measuring block stops its measurement when the at least one time measuring block has reached a predetermined limit value; evaluating, using the evaluation block, the measurement result of the at least one time measuring block at the end of the predetermined time; setting the transmitting module for operation in the first communication phase or for operation in the second communication phase on the basis of the evaluation result, and transmitting, using the transmitting module, a digital, pulse-width-demodulated transmission signal as an analog differential signal onto the bus of the bus system in order to transmit a message to at least one other subscriber station of the bus system, wherein bits in the digital, pulse-width-demodulated transmission signal have a longer bit duration in a first communication phase than in a second communication phase of the transmission signal.

The method of the present invention offers the same advantages as those mentioned above in relation to the interface module of the present invention.

Further possible implementations of the present invention also include combinations, even those not explicitly mentioned, of features or embodiments described above or below with respect to the exemplary embodiments. In this case, a person skilled in the art will also add individual aspects as improvements or additions to the relevant basic form of the present invention.

### BRIEF DESCRIPTION OF THE DRAWINGS

The present invention is described in more detail below with reference to the figures and on the basis of exemplary embodiments.

FIG. 1 shows a simplified block diagram of a bus system according to a first exemplary embodiment of the present invention.

FIG. 2 shows a diagram for illustrating the structure of a message that can be transmitted by a subscriber station of the bus system according to the first exemplary embodiment of the present invention.

FIG. 3 shows an example of the ideal time sequence of bus signals CAN_H, CAN_L, which are sent to a bus of the bus system by subscriber stations of the bus system for the message in FIG. 2.

FIG. 4 shows the time sequence of a differential voltage VDIFF which forms on the bus of the bus system as a result of the bus signals in FIG. 3.

FIG. 5 shows a block diagram of transmitting/receiving device for a subscriber station of the bus system according to the first exemplary embodiment of the present invention.

FIG. 6 shows an example of a time sequence of a digital transmission signal which in the data phase of a message indicates to the transmitting/receiving device for a transmitting node the switching to an operating mode for transmitting.

FIG. 7 shows the temporal course of a digital transmission signal which the transmitting/receiving device generates from the signal in FIG. 6 in order to transmit the message to the bus.

FIG. 8 shows an example of a temporal course of a digital transmission signal which in the data phase of a message indicates to the transmitting/receiving device for a receiving node the switching to an operating mode for receiving.

FIG. 9 shows the temporal course of a digital transmission signal which the transmitting/receiving device generates from the signal in FIG. 8.

FIG. 10 to FIG. 15 show signal courses to explain the function of an interface module of the transmitting/receiving device for the case in which the associated subscriber station is the transmitter of the message to the bus in the data phase (transmitting node) and for which reason the transmitting/receiving device is switched in the data phase to an operating mode for transmitting the transmission signal to the bus.

FIG. 16 to FIG. 21 show signal waveforms to explain the function of the interface module of the transmitting/receiving device for the case in which the associated subscriber station in the data phase is only a receiver, but not a transmitter, of the message on the bus (receiving node) and for which reason the transmitting/receiving device is switched in the data phase to an operating mode for receiving the message from the bus.

In the figures, identical or functionally identical elements are given the same reference signs unless otherwise indicated.

### DETAILED DESCRIPTION OF EXAMPLE EMBODIMENTS

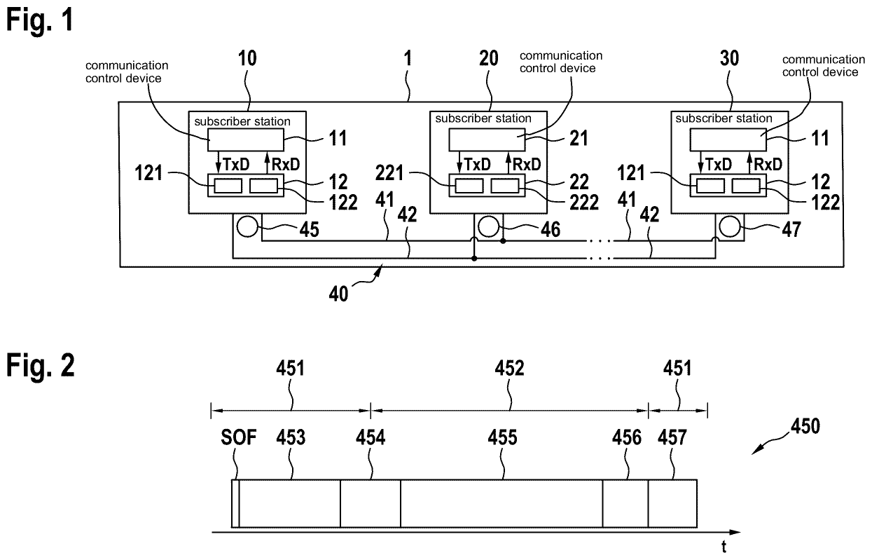

FIG. 1 shows a bus system 1, which can, for example, at least in sections, be a CAN bus system, a CAN-FD bus system, etc. The bus system 1 can be used in a vehicle, in particular a motor vehicle, an aircraft, etc., or in a hospital, etc.

In FIG. 1, the bus system 1 has a plurality of subscriber stations 10, 20, 30, which are each connected to a bus 40 with a first bus wire 41 and a second bus wire 42. The bus wires 41, 42 can also be referred to as CAN_H and CAN_L for the signals on the bus 40. Messages 45, 46, 47 in the form of signals can be transmitted between the individual subscriber stations 10, 20, 30 via the bus 40. The subscriber stations 10, 20, 30 are, for example, control devices or display devices of a motor vehicle. As shown in FIG. 1, the subscriber stations 10, 30 each have a communication control device 11 and a transmitting/receiving device 12. The transmitting/receiving device 12 has a transmitting module 121 and a receiving module 122.

The subscriber station 20 has a communication control device 21 and a transmitting/receiving device 22. The transmitting/receiving device 22 has a transmitting module 221 and a receiving module 222.

The transmitting/receiving devices 12 of the subscriber stations 10, 30 and the transmitting/receiving device 22 of the subscriber station 20 are in each case directly connected to the bus 40, even if this is not shown in FIG. 1.

The communication control devices 11, 21 are each used for controlling a communication of the relevant subscriber station 10, 20, 30 via the bus 40 with at least one other subscriber station of the subscriber stations 10, 20, 30 which are connected to the bus 40.

The communication control device 11 creates and reads first messages 45, 47, which are, for example, modified CAN messages 45, 47. Here the modified CAN messages 45, 47 are based on the CAN XL format, for example. The transmitting/receiving device 12 serves for transmitting and receiving the messages 45, 47 from the bus 40. The transmitting module 121 receives a digital transmission signal TxD created by the communication control device 11 for one of the messages 45, 47 and converts this into signals on the bus 40. The digital transmission signal TxD can be a pulse-width-modulated signal, at least in sections. The receiving module 122 receives signals transmitted on the bus 40 corresponding to the messages 45 to 47 and from these generates a digital reception signal RxD. The receiving module 122 sends the reception signal RxD to the communication control device 11. In addition, the communication control device 11 can be designed to create and read second messages 46, which are, for example, CAN SiC messages 46. The transmitting/receiving device 12 can be designed accordingly.

The communication control device 21 can be designed as a conventional CAN controller according to ISO 11898-1:2015, i.e. as a CAN FD-tolerant Classical CAN controller or as a CAN FD controller. The communication control device 21 creates and reads second messages 46, for example CAN SiC messages. The transmitting/receiving device 22 serves for transmitting and receiving the messages 46 from the bus 40. The transmitting module 221 receives a digital transmission signal TxD created by the communication control device 21 and converts this into signals for a message 46 on the bus 40. The receiving module 222 receives signals transmitted on the bus 40 corresponding to the messages 45 to 47 and from these generates a digital reception signal RxD. The transmitting/receiving device 22 may be designed like a conventional CAN SiC transceiver.

To transmit messages 45, 46, 47 with CAN SiC or CAN XL, proven properties are adopted that are responsible for the robustness and user-friendliness of CAN and CAN FD, in particular the frame structure with identifier and arbitration according to the well-conventional CSMA/CR method. The CSMA/CR method has the consequence that so-called recessive states are mandatory on the bus 40, which can be overwritten on the bus 40 with dominant levels or dominant states by other subscriber stations 10, 20, 30.

With the two subscriber stations 10, 30, a formation and then a transmission of messages 45, 47 with different CAN formats, in particular the CAN FD format or the CAN SiC format or the CAN XL format, as well as the reception of such messages 45, 47, can be realized. This is described in more detail below for a message 45.

FIG. 2 shows for the message 45 a frame 450, which is in particular a CAN XL frame, such as is provided by the communication control device 11 for the transmitting/receiving device 12 for transmission to the bus 40. Here, the communication control device 11 creates the frame 450 in the present exemplary embodiment as compatible with CAN FD. Alternatively, the frame 450 is compatible with any successor standard for CAN FD.

According to FIG. 2, for CAN communication on the bus 40 the frame 450 is divided into different communication phases 451, 452, namely an arbitration phase 451 (first communication phase) and a data phase 452 (second communication phase). The frame 450 has, following a start bit SOF, an arbitration field 453, a control field 454, a data field 455, a checksum field 456 and a frame termination field 457. The checksum field 456 and the frame termination field 457 form a frame end phase 456, 457 of the frame 450.

In the arbitration phase 451, with the aid of an identifier (ID) in the arbitration field 453, negotiation takes place bitwise between the subscriber stations 10, 20, 30 as to which subscriber station 10, 20, 30 wishes to transmit the message 45, 46 with the highest priority and will therefore receive exclusive access to the bus 40 of the bus system 1 for the next time for transmitting in the subsequent data phase 452. A physical layer such as in CAN and CAN FD is used in the arbitration phase 451. The physical layer corresponds to the bit transmission layer or layer 1 of the convention OSI model (Open Systems Interconnection Model).

An important point during the phase 451 is that the conventional CSMA/CR method is used, which allows simultaneous access of the subscriber stations 10, 20, 30 to the bus 40 without the higher-priority message 45, 46 being destroyed. As a result, further bus subscriber stations 10, 20, 30 can be added relatively easily to the bus system 1, which is very advantageous.

The CSMA/CR method has the consequence that so-called recessive states are mandatory on the bus 40, which can be overwritten on the bus 40 with dominant levels or dominant states by other subscriber stations 10, 20, 30. In the recessive state, high-impedance conditions prevail at the individual subscriber station 10, 20, 30, which in combination with the parasites on the bus circuit results in longer time constants. This leads to a limitation of the maximum bit rate of the present-day CAN-FD physical layer at currently about 2 megabits per second in real vehicle use.

In the data phase 452, in addition to a portion of the control field 454, the payload data of the CAN XL frame 450 or of the message 45 are transmitted from the data field 455 as well as the checksum field 456. The checksum field 456 may contain a checksum of the data of the data phase 452 including the stuff bits, which are inserted by the transmitter of the message 45 as an inverse bit after each predetermined number of identical bits, in particular 10 identical bits. At the end of the data phase 452, the system switches back to the arbitration phase 451.

An end field in the frame termination field 457 may contain at least one acknowledge bit. This can be followed by a sequence of 11 identical bits that indicate the end of the CAN XL frame 450. The at least one acknowledge bit can be used to indicate whether or not a receiver has detected an error in the received CAN XL frame 450 or in the message 45.

A transmitter of the message 45 begins to transmit bits of the data phase 452 to the bus 40 only when the subscriber station 10 as the transmitter has won the arbitration and the subscriber station 10 as transmitter thus has exclusive access to the bus 40 of the bus system 1 for transmitting.

In the arbitration phase 451 as the first communication phase the subscriber stations 10, 30 thus use in part, in particular up to the FDF bit (inclusive), a format from CAN/CAN FD according to ISO11898-1:2015. However, compared to CAN or CAN FD, an increase in the net data transfer rate, in particular to over 10 megabits per second, is possible in the data phase 452 as the second communication phase. Increasing the size of the payload data per frame, in particular to about 2 kbyte or any other value, is also possible.

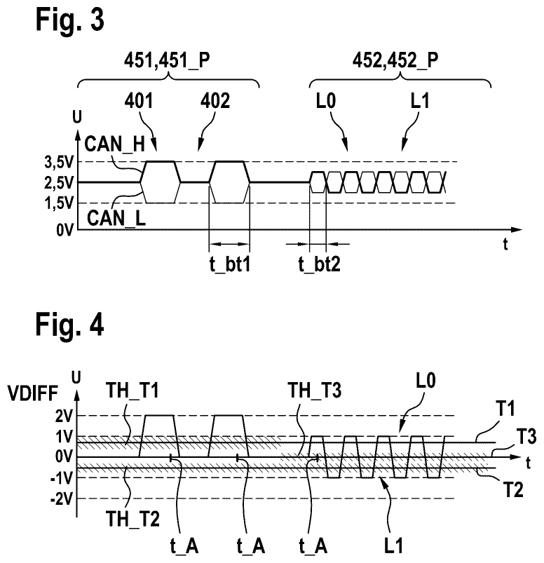

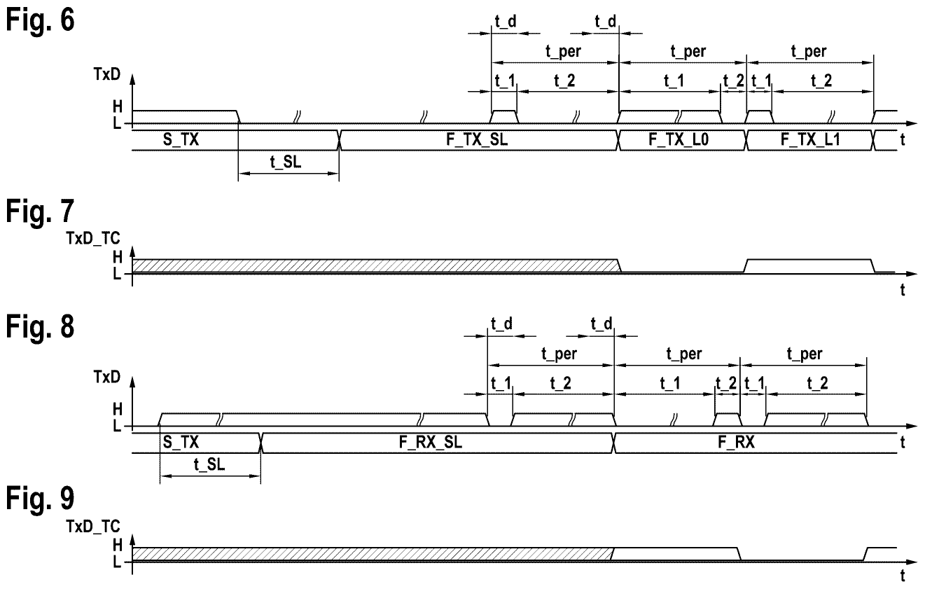

As shown in FIG. 3, in the arbitration phase 451, the transmitting/receiving devices 12 use a physical layer 451_P to transmit to the bus 40 a transmission signal TxD (FIG. 1) over time t as signals CAN_H, CAN_L. The same applies to the transmitting/receiving device 22. In contrast, in the data phase 452 the transmitting/receiving device 12 may use a physical layer 452_P that is different from the physical layer 451_P in order to transmit to the bus 40 the transmission signal TxD (FIG. 1) as signals CAN_H, CAN_L, as described above. There are two operating modes for the physical layer 452_P, namely FAST_TX and FAST_RX, as described in more detail below. The course of the corresponding transmission signals is explained in more detail below with the aid of FIG. 6 to FIG. 21.

FIG. 3 shows on the left side that in the arbitration phase 451 the subscriber stations 10, 20, 30 each transmit signals CAN_H, CAN_L over time t to the bus 40, which have a first bit duration t_bt1. The signals CAN_H, CAN_L are serial signals and have alternatingly at least one dominant state 401 or at least one recessive state 402. After arbitration in the arbitration phase 451, one of the subscriber stations 10, 20, 30 emerges the winner.

Assuming that the first subscriber station 10 has won the arbitration, at the end of the arbitration phase 451, the transmitting/receiving device 12 of the subscriber station 10 switches its physical layer 451_P from a first operating mode (SLOW), which can also be implemented as an SiC operating mode, to a second operating mode (FAST_TX), since in the data phase 452 the subscriber station 10 is the transmitter of the message 45. As shown in FIG. 3, in the data phase 452 or in the second operating mode (FAST_TX) the transmitting module 121 then, depending on a transmission signal TxD, generates the states L0 or L1 with the physical layer 452_P for the signals CAN_H, CAN_L on the bus 40, one after the other and thus serially. The frequency of the signals CAN_H, CAN_L can be increased in the data phase 452. In the example in FIG. 3, the bit time or bit duration t_bt2 in the data phase 452 is shorter or less than the bit time or bit duration t_bt1 in the arbitration phase 451. In the example in FIG. 3, the net data transfer rate in the data phase 452 is thus increased compared to the arbitration phase 451. In contrast, at the end of the arbitration phase 451 the transmitting/receiving device 12 of the subscriber station 30 switches its physical layer 451_P from the first operating mode (SLOW or SiC) to a third operating mode (FAST_RX), since in the data phase 452 the subscriber station 30 is only a receiver, i.e. not a transmitter, of the frame 450.

If the transmitting/receiving device 12 detects that a switchover from the data phase 452 back to the arbitration phase 451 is to be made, the transmitting/receiving device 12 will be switched from transmitting (operating mode FAST_TX) and/or receiving (operating mode FAST_RX) signals with the physical layer 452_P to transmitting and/or receiving in the physical layer 451_P. Accordingly, after the end of the arbitration phase 451 all transmitting/receiving devices 12 of the subscriber stations 10, 30 switch their operating mode to the first operating mode (SLOW or SiC). All transmitting/receiving devices 12 can thus not only switch between the bit durations t_bt1, t_bt2 but also switch their physical layer, as described above.

According to FIG. 4, in the arbitration phase 451 over time t in the ideal case a difference signal VDIFF=CAN_H-CAN_L with values of VDIFF=2V for dominant states 401 and VDIFF=0V for recessive states 402 is formed on the bus 40. This is shown on the left-hand side in FIG. 4. In contrast, in the data phase 452, a difference signal VDIFF=CAN_H−CAN_L corresponding to the states L0, L1 in FIG. 4 is formed over time t on the bus 40, as shown on the right-hand side in FIG. 4. The state L0 has a value VDIFF=1V. The state L1 has a value VDIFF=−1V.

The receiving module 122 can distinguish the states 401, 402 with in each case two of the receiving thresholds T1, T2, T3, which lie in the ranges TH_T1, TH_T2, TH_T3. For this purpose, the receiving module 122 samples the signals in FIG. 3 or FIG. 4 at times t_A, as shown in FIG. 4. To evaluate the sampling result, in the arbitration phase 451 the receiving module 122 uses the receiving threshold T1 of, for example, 0.7 V and the receiving threshold T2 of, for example, −0.35 V. In contrast, in the data phase 452 the receiving module 122 only uses signals that were evaluated with the receiving threshold T3. When switching between the first to third operating modes (SLOW or SiC, FAST_TX, FAST_RX) described above with reference to FIG. 3, the receiving module 122 switches in each case the receiving thresholds T2, T3.

The receiving threshold T2 is used to detect whether the bus 40 is free when the subscriber station 12 is newly connected to communication on the bus 40 and attempts to integrate itself into communication on the bus 40. Each subscriber station 10, 30 switches the operating mode of the transmitting/receiving device 12 to the operating mode of the arbitration phase 451 when the subscriber station 12 is (newly) connected to communication on the bus 40 or attempts to reintegrate into communication on the bus 40 following an error in bus communication. Only when it is detected that the bus 40 is free, may the subscriber station 10 in the cases mentioned itself transmit data, in particular messages 45, 47, to the bus 40.

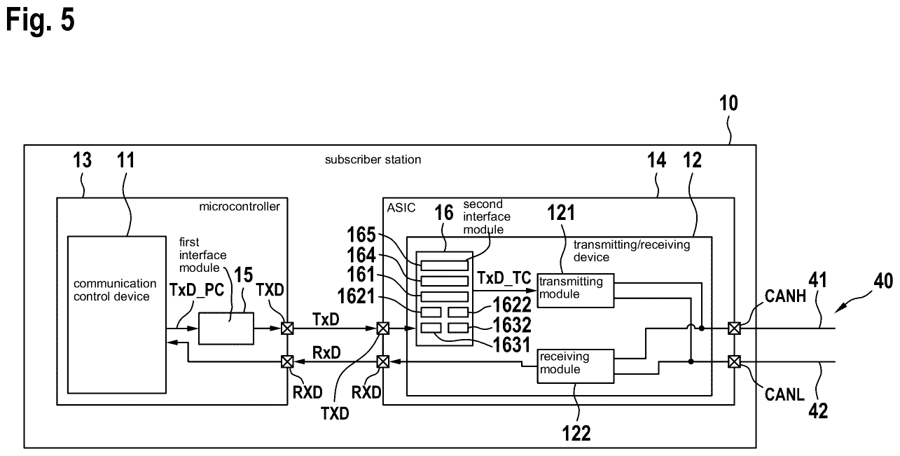

Upon receiving the corresponding signals from the bus 40, each transmitting/receiving device 12 generates the associated reception signal RxD, as illustrated in FIG. 1 and FIG. 5. Ideally, the reception signal RxD has no time offset from the transmission signal TxD.

FIG. 5 shows the basic structure of the subscriber station 10 with its communication control device 11 and its transmitting/receiving device 12 which comprises the transmitting module 121 and the receiving module 122. The subscriber station 10 also has a microcontroller 13, a system ASIC (ASIC=application-specific integrated circuit) 14, a first interface module 15 and a second interface module 16. The second interface module 16 has time measuring blocks 161, 1621, 1622, 1631, 1632, a switching block 164, and an evaluation block 165.

The first interface module 15 is assigned to the microcontroller 13 and to the device 11. The first interface module 15 is arranged between the device 11 and a terminal TXD of the microcontroller 13. The first interface module 15 is connected to the terminal TXD of the microcontroller 13. The first interface module 15 outputs a signal TxD to the second interface module 16.

The second interface module 16 is assigned to the device 12 and to the system ASIC 14. The second interface module 16 is arranged between a terminal TXD of the system ASIC 14 and the transmitting module 121. The second interface module 16 is connected to the terminal TXD of the system ASIC 14 and/or a corresponding terminal TXD of the device 12.

The communication control device 11 can be designed as a protocol controller for transmitting and/or receiving CAN XL messages 45, 47. Optionally, the device 11 is designed for transmitting and/or receiving CAN FD or CAN SiC messages 46.

The microcontroller 13 generates or processes data which are to be converted by the device 11 into the corresponding frame format for transmitting messages 45, 47 via the bus 40. To transmit the data on the bus 40, the communication control device 11 generates a transmission signal TxD_PC according to the corresponding standard for CAN FD, CAN SiC or CAN XL messages 45, 47 and outputs the transmission signal TxD_PC to the first interface module 15.

The first interface module 15 is designed for pulse-width modulation (PWM) of the transmission signal TxD_PC. Accordingly, the transmission signal TxD at the terminal TXD of the microcontroller 13 is a transmission signal that is pulse-width-modulated at least in parts.

The second interface module 16 is designed to process the transmission signal TxD. In particular, the second interface module 16 is designed for pulse-width demodulation of the transmission signal TxD. Consequently, the transmission signal TxD_TC output by the module 16 is a decoded or pulse-width- demodulated transmission signal. These functions are explained in more detail with the aid of FIG. 6 to FIG. 9.

The system ASIC 14 of the subscriber station 10 in FIG. 5 can alternatively be a system basis chip (SBC) on which several functions necessary for an electronic module of the subscriber station 10 are combined. In the ASIC 14 system, a power supply device, not shown, which supplies the transmitting/receiving device 12 with electrical energy can be installed in addition to the transmitting/receiving device 12. The power supply device usually supplies a voltage CAN_supply of 5 V. Depending on requirements, however, the power supply device 19 can provide a different voltage with a different value. Additionally or alternatively, the power supply device can be designed as a current source.

FIG. 5 shows the transmitting module 121 only in a simplified representation. The transmitting module 121 is connected directly to the bus 40 via terminals CANH, CANL in order to be able to transmit a transmission signal TxD TC of the second interface module 16 to the bus 40.

According to FIG. 5, the receiving module 122 is also directly connected to the bus 40 via the terminals CANH, CANL. The receiving module 122 is designed to generate the digital reception signal RxD. The receiving module 122 transmits or outputs the reception signal RxD to the terminal RXD of the microcontroller 13 or the communication control device 11 via the terminal RXD of the system ASIC 14 or of the transmitting/receiving device 12.

In the present exemplary embodiment, the time measuring blocks 161, 1621, 1622, 1631, 1632 are in each case designed as counters. The switching block 164 operates or clocks the measuring, in particular the counting, of the time measuring blocks 161, 1621, 1622, 1631, 1632. The time measuring blocks 161, 1621, 1622, 1631, 1632 do not carry out their measurements permanently but rather at predetermined time intervals or intermittently.

The switching block 164 may be designed as an oscillator block that outputs an oscillating signal FO (FIG. 12) with a clock TK or a frequency f that corresponds to the period of the signal in FIG. 12. The clock TK, and thus also the frequency f, is tuned to a time t_d in FIG. 6 or t-decode. In the time period or time t_d, during sampling of a bit of the transmission signal TxD, the level or bit value of the bit is to be determined, namely high (H=high) or low (L=low). The time t_d in FIG. 6 begins or ends with a bit of the transmission signal TxD. In addition, the value of the bit in the middle of a bit can be sampled with the time t_d (FIG. 6), which starts or ends with the middle of the bit time period t per. Since the time t_d is set to be not less than or shorter than 5 ns, the frequency f of the switching block 164 is chosen to be f>200 MHz, in particular about 300 MHz. This means that the requirement for time t_d can be met. The bit time t per of bits of the data phase 452 can have a value<205 ns in the example given. As described in more detail below, the time period t_per is divided into the time periods t_1, t_2. Each of the time periods t_1, t_2 must not be shorter or less than 5 ns.

The time measuring block 161 is provided for preselecting the operating mode of the data phase 452. The time measuring blocks 1621, 1622 are provided for detecting bits of the transmission signal TxD which have the bit time t_bt2. The time measuring blocks 1621, 1631 are used to detect whether the data or bits in the transmission signal TxD are transmitted pulse-modulated in the FAST_TX operating mode. The time measuring blocks 1622, 1632 are used to detect whether the data or bits in the transmission signal TxD are transmitted pulse-modulated in the FAST_RX operating mode.

FIG. 6 shows an example of a transmission signal TxD for a transmitting node, which the second interface module 16 receives from the first interface module 15 over time t, and thus serially. FIG. 7 shows the transmission signal TxD_TC, which the interface module 16 generates from the signal in FIG. 6 over time t for the transmitting module 121. FIG. 8 and FIG. 9 show for a receiving node other examples of the transmission signal TxD and the transmission signal TxD_TC generated from it.

FIG. 6 and FIG. 8 each show the part of the transmission signal TxD of a message 45 at the end of the arbitration phase 451. In this phase, the transmitting module 121 is switched to the SLOW or SiC operating mode, as shown in FIG. 6 and FIG. 8 in each case by the state S_TX.

If an edge occurs in the TxD signal, as shown in FIG. 6 and FIG. 8, the time period t_SL will begin running and the time measuring block 161 starts a time measurement. The time period t_SL corresponds to the time period t_select, whereby according to CiA610-3 t_select=500 . . . 980 ns. Measurement with the time measuring block 161 begins again with each edge of the transmission signal TxD. After the time period t SL has elapsed, the time measuring block 161 stops its measurement and the evaluation block 165 detects the level of the transmission signal TxD. If this level is L (low), the evaluation block 165 specifies the operating mode FAST_TX, as indicated in FIG. 6 with the state F_TX_SL. The FAST_TX operating mode is thus preselected for the transmitting/receiving device 12 towards the end of the arbitration phase 451. If, on the other hand, the level H (high) is evaluated at the end of the time period t_SL, the evaluation block 165 specifies the operating mode FAST_RX, as indicated in FIG. 8 with the state F_RX_SL. The FAST_RX operating mode is thus preselected for the transmitting/receiving device 12 towards the end of the arbitration phase 451.

In addition, if the FAST_TX operating mode is preselected, as indicated in FIG. 6 with the state F_TX_SL, the time measuring block 1621 begins to measure whether two rising edges of the transmission signal TxD are transmitted in a time window having a temporal length equal to the time period or symbol duration t_per. The time period t_per is in particular equal to the time period t_bt2. The time period t_bt2 corresponds to the time period tfast, whereby according to CiA610-3 tfast=205 . . . 245 ns. Starting with a rising edge of the transmission signal TxD, the time measuring block 1621 measures whether two consecutive rising edges occur in the symbol duration t_per of the transmission signal TxD. The time measuring block 1621 stops measurement once the time period t_bt2 is reached. If two consecutive rising edges occur in the symbol duration t_per of the transmission signal TxD, the evaluation block 165 recognizes that the transmitting/receiving device 12 is to be switched to the FAST_TX operating mode, as indicated in FIG. 6 with the state F_TX for the levels F_TX)L1 and F_TX_L0. The FAST_TX operating mode is deactivated again when the evaluation block 165 detects that a longer or shorter time period than the time period t_bt2 elapses between two consecutive rising edges in the transmission signal TxD. In addition, the FAST_TX operating mode is exited or deactivated again if the evaluation block 165 detects that the transmission signal TxD has the level H or L for a predetermined long time, in particular permanently.

At the end of and after the arbitration phase 451, the transmission signal TxD in FIG. 6 is a sectionally pulse-width-modulated signal (PWM signal). In the pulse-width-modulated signal, PWM symbols have the symbol duration t_per, which in turn is divided into the time periods t_1, t_2. The transmission signal TxD changes after the time period t_1 from a first level, for example L (low), to a second level, for example H (high), as shown in FIG. 6. The evaluation block 165 evaluates, with the aid of the levels L, H of the transmission signal TxD and the time periods t_1, t_2, which PWM symbol is encoded in the transmission signal TxD, and thus which level is to be created for bits in the transmission signal TxD_TC in FIG. 7 in order to generate with the transmitting module 121 the associated state (L1, L0 in FIG. 4) on the bus 40. For this purpose, the evaluation block 165 evaluates the measurements of at least two of the time measuring blocks 1621, 1622, 1631, 1632 as described in more detail below.

In addition, if the FAST_RX operating mode is preselected, as indicated in FIG. 8 with the state F_RX_SL, the time measuring block 1622 begins to measure whether two falling edges of the transmission signal TxD are transmitted in a time window having a time length equal to the time period of a PWM symbol or symbol duration t_per. The time period t_per is in particular equal to the time period t_bt2, as mentioned above. The time measuring block 1622 measures, starting or beginning with a falling edge of the transmission signal TxD, whether two consecutive falling edges occur in the symbol duration t_per of the transmission signal TxD. The time measuring block 1622 stops measurement once the time period t_bt2 is reached. If two consecutive falling edges occur in the symbol duration t_per of PWM symbols of the transmission signal TxD, the evaluation block 165 recognizes that the transmitting/receiving device 12 is to be switched to the FAST_RX operating mode, as indicated in FIG. 8 with the state F_RX. The FAST_RX operating mode is deactivated again when the evaluation block 165 detects that a longer or shorter time period than the time period t_bt2 elapses between two consecutive falling edges in the transmission signal TxD. In addition, the FAST_RX operating mode is quit or deactivated again if the evaluation block 165 detects that the transmission signal TxD has the level H or L for a predetermined long time, in particular permanently.

To decode the pulse-width-modulated signal TxD in FIG. 6 into the signal TxD_TC in FIG. 7, the following procedure can be followed. The same applies to decoding the pulse-width-modulated signal TxD in FIG. 8 into the signal TxD_TC in FIG. 9.

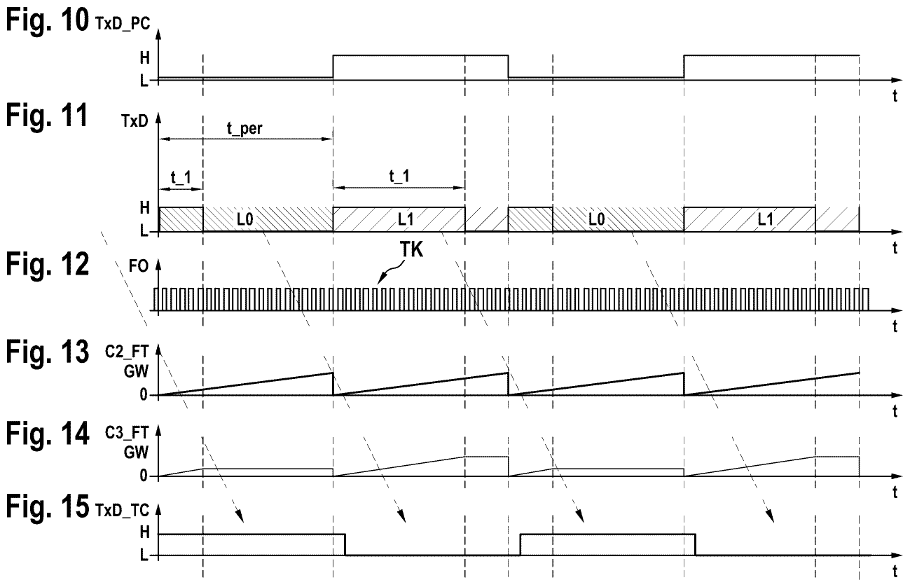

FIG. 10 shows for the data phase 452 an example of a transmission signal TxD_PC, which the device 11 in FIG. 3 generates over time t with the values H, L for bits with the symbol duration t_per or bit time or bit_duration t_bt2 and outputs serially to the first interface module 15 in FIG. 3. FIG. 11 shows the transmission signal TxD, which the first interface module 15 generates from the signal in FIG. 10 by means of pulse modulation and outputs serially to the terminal TXD of the device 12 in FIG. 3. The transmission signal TxD encodes with PWM symbols the states L0, L1 for the bus signal in FIG. 4, as mentioned above. The time t_2 in the signal TxD in FIG. 11 corresponds to the on time of the transmission signal TxD. The on time is the time for which the transmission signal TxD has the level H or is switched on. For the remaining time at the start or from the beginning of the symbol time t_per, the transmission signal TxD has the level L or is switched off. If communication takes place on bus 40 at 10 Mbit/s, the symbol duration t_per will have a length of 100 ns, for example. In this case, the time t_1 for a PWM symbol encoding the state L0 can be chosen to be, for example, 25 ns. In addition, a length of 75 ns can be chosen as the time t_1 for a PWM symbol that encodes the state L1. The time t_1 is therefore either, for example, 25% of the symbol duration t_per or, for example, 75% of the symbol duration t_per, in order to encode the states L0, L1. Of course, other time lengths for the time t_1 are possible, in particular those permitted by the CiA610-3 standard for CAN XL.

The transmission signal TxD is demodulated or decoded in the second interface module 16. Here, the oscillator signal FO in FIG. 12 is used to trigger the time measuring blocks 161, 1621, 1622, 1631, 1632. With the aid of the corresponding signals in FIG. 13 and FIG. 14, the second interface module 16 generates the transmission signal TxD_TC, as already mentioned above. The second interface module 16 generates the transmission signal TxD_TC with a predetermined time offset to the transmission signal TxD, as shown by the arrows between FIG. 11 and FIG. 15. According to FIG. 11 and FIG. 15, the time offset is slightly more than one bit time or bit_duration t_bt2.

If the FAST_TX operating mode is preselected, as indicated in FIG. 6 with the state F_TX_SL, the time measuring block 1621 begins measuring from one rising edge to the next rising edge of the transmission signal TxD, as shown in FIG. 13. The count value C2_FT of the time measuring block 1621 increases maximally up to a limit value GW, which corresponds to the time period t_per or t_bt2. The time measuring block 1621 stops when the limit value GW (maximum count value) or the time period t_per is reached. In addition, as shown in FIG. 14, the time measuring block 1631 begins measuring from one rising edge to the next falling edge of the transmission signal TxD. The time measuring block 1631 stops when the time period t_per is reached. At the end of the PWM symbol, i.e. the second rising edge of the transmission signal TxD, the PWM symbol is decoded. The digital circuit_design allows an easy halving of the count value C2_FT of the time measuring block 1631 by means of a digital shift operation by one place. The comparison then takes place. The evaluation block 165 evaluates the state L1 as a value for the measured PWM symbol of the transmission signal TxD if the count value C3_FT<count value C2_FT/2, so that the value L is to be generated in the transmission signal TxD_TC in FIG. 15. The evaluation block 165 evaluates L0 as the value for the measured PWM symbol of the transmission signal TxD if count value C3_FT>count value C2_FT/2, so that the value L is to be generated in the transmission signal TxD_TC in FIG. 15. It is not_defined which value or level is to be generated in the transmission signal TxD_TC if count value C3_FT=count value C2_FT/2.

The respective result of the evaluation by the evaluation block 165 is passed on to the transmitting module 121 as the decoded transmission signal TxD_TC in FIG. 15. The transmitting module 121 converts an L level of the transmission signal TxD_TC into an L0 signal or an L0 state on the bus (VDIFF=1V, FIG. 4). The transmitting module 121 converts an H level of the transmission signal TxD_TC into an L1 signal or an L1 state on the bus 40 (VDIFF=−1V, FIG. 4).

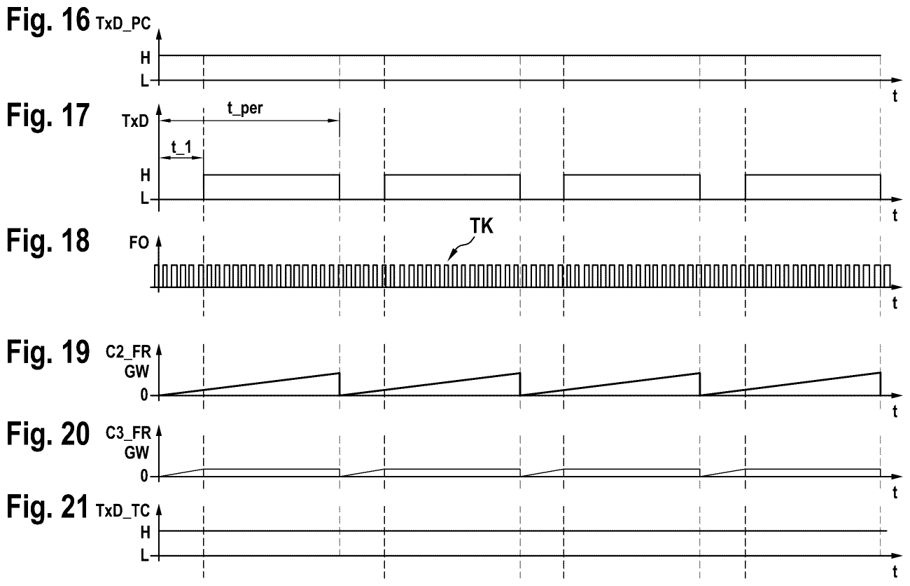

FIG. 16 to FIG. 21 show the corresponding signals for a receiving node for which the FAST_RX operating mode is preselected for the data phase 452, as indicated in FIG. 8 with the state F_RX_SL. In this case, the transmission signal TxD_PC is transmitted with level H in the data phase 452, as shown in FIG. 16. The interface module 15 generates the transmission signal TxD accordingly with PWM symbols L1, as shown in FIG. 17. In this case, triggered by the signal according to FIG. 18 of the switching block 164, the time measuring block 1622 begins measuring from a falling edge of the transmission signal TxD to the next falling edge of the transmission signal TxD. The time measuring block 1622 thus measures the duration of the time period t_per. The count value C2_FR of the time measuring block 1622 in FIG. 19 increases maximally up to a limit value GW which corresponds to the time period t_per. The time measuring block 1622 stops when the limit value GW or the time period t_per is reached. In addition, as shown in FIG. 20, the time measuring block 1632 begins measuring from a falling edge of the transmission signal TxD to the next rising edge of the transmission signal TxD. The time measuring block 1632 thus measures the duration of the off time of the PWM symbol. The time measuring block 1632 stops when the time period t_per or t_bt2 is reached. At the end of the PWM symbol, i.e. of the second falling edge of the transmission signal TxD in FIG. 17, validation of the PWM symbol is undertaken. The PWM symbol is accepted by the evaluation block 165 if C3_FR>1 and C3_FR<GW−1. If the PWM symbol is accepted, an H level will be evaluated as the value for the measured PWM symbol of the transmission signal TxD. The H level corresponds to a recessive state 402 (FIG. 4) on the bus 40.

The above-described design of the second interface module 16 forms a digital circuit concept. This concept makes possible a high degree of accuracy in the execution of the three functions (operating mode preselection, detection of the bit time t_bt2 of the data phase 452 for switching between the operating modes for the transmitting module 121, decoding of the PWM symbols of the transmission signal TxD) of the second interface module 16. This is made possible by using a balanced circuit block 164, in particular a ring oscillator block which outputs an oscillating signal FO, as shown in FIG. 12. The achievable accuracy is approximately +/−7%.

An advantage of the second interface module 16 is in particular the high accuracy for evaluating the pulse-modulated signal TxD, since the time measuring blocks 161, 1621, 1622, 1631, 1632 are operated with the same clock TK or the same frequency f of the switching block 164. This in particular also applies to the time measuring blocks 1621, 1622 for period t_bt2 and the time measuring blocks 1631, 1632 for the on time t_1 or off time t_2, since the time measuring blocks 161, 1621, 1622, 1631, 1632 also work very well together.

In addition, the above-described design of the second interface module 16 makes a very low silicon area consumption possible in the hardware. This makes the interface module 16 very inexpensive and space-saving. This also contributes to the fact that a higher-level transmitting/receiving device (transceiver) 12 can be manufactured very inexpensively and in a space-saving manner.

Yet another advantage of the second interface module 16 lies in a high test coverage and the associated component quality.

In addition, there is a high degree of flexibility for adaptations in additional development steps of the second interface module 16.

There is also the option of using the second interface module 16 as a digital part in a CAN-XL transmitting/receiving device 12. This allows functional expansions in the device 12, such as security functions, particularly against manipulation.

According to a second exemplary embodiment, the evaluation block 165 is designed to additionally evaluate the measurement of the time measuring block 1632 in the FAST_RX operating mode. The FAST_RX operating mode remains active for as long as the value of the time measuring block 1632 is greater than or equal to 1*t_d, AND the value of the time measuring block 1632 is less than the value of the time measuring block 1622 minus 1*t_d.

This provides a redundancy which prevents the FAST_RX operating mode from being deactivated too quickly or remaining active for too long.

According to a third exemplary embodiment, at least one of the time measuring blocks 161, 1621, 1622, 1631, 1632 is realized according to an analog circuit concept.

In contrast to the transmitting/receiving device 12 of the above-described exemplary embodiment, at least one of the time measuring blocks 161, 1621, 1622, 1631, 1632 is designed to carry out the above-described time measurement_doing so using at least one switched constant current. At least one of the time measuring blocks 161, 1621, 1622, 1631, 1632 comprises a capacitor. In addition, the at least one time measuring block 161, 1621, 1622, 1631, 1632 has at least one voltmeter for measuring the voltage across the capacitor.

The constant currents are switched in such a way that the capacitor is charged or discharged as required. The evaluation block 165 can be designed to evaluate the voltage measurement. The evaluation block 165 can in particular carry out a voltage comparison of the measured capacitor voltages.

Accordingly, the switching block 164 may include at least one switchable constant current source. The switching block 164 is designed to switch the at least one constant current source in order to charge the capacitor over time. The at least one time measuring block 161, 1621, 1622, 1631, 1632 is designed to stop the switching of the at least one constant current source and thus the charging of the at least one capacitor at a predetermined limit voltage value (GW) which corresponds to the predetermined time t_per or t_1 or t_bt2 or t SL.

In this way too, the functions described above for the second interface module 16 in the above-described embodiments can also be advantageously implemented.

However, such an implementation requires a significantly higher silicon area consumption for the second interface module 16 than in the above-described embodiments.

All above-described embodiments of the interface module 16 of the transmitting/receiving device 12, of the subscriber stations 10, 20, 30, the bus system 1 and of the method carried out therein according to the exemplary embodiments and their modifications can be used individually or in all possible combinations. Additionally or alternatively, the following modifications are in particular possible.

The above-described bus system 1 according to at least one of the exemplary embodiments is described on the basis of a bus system based on the CAN protocol. However, the bus system 1 according to at least one of the exemplary embodiments may alternatively be another type of communication network in which the signals are transmitted as differential signals. It is advantageous, but not a necessary condition, for an exclusive, collision-free access of a subscriber station 10, 20, 30 to the bus 40 to be ensured in the case of the bus system 1, at least for certain time periods.

The bus system 1 according to at least one of the exemplary embodiments and their modifications is in particular a bus system in which communication can take place between at least two of the subscriber stations 10, 20, 30 according to two different CAN standards, such as CAN-HS or CAN FD or CAN SiC or CAN XL. However, the bus system 1 may be another communication network in which the signals are transmitted as differential signals and serially via the bus 40. The functionality of the above-described exemplary embodiments can thus be used, for example, in transmitting/receiving devices 12, 22 that are to be operated in such a bus system.

The number and arrangement of the subscriber stations 10, 20, 30 in the bus system 1 according to at least one of the exemplary embodiments and their modifications can be selected as desired.

1-16. (canceled)

17. An interface module fr a subscriber station of a serial bus system, wherein in the serial sub system has a transmitting module configured to transmit a digital transmission signal as an analog differential signal onto a bus of the bus system to transmit a message to at least one other subscriber station of the bus system, wherein bits in the digital transmission signal have a longer bit duration in a first communication phase than in a second communication phase of the transmission signal, the interface module comprising:
at least one time measuring block configured to measure, with a predetermined timing clock, a predetermined time in a digital transmission signal, wherein the at least one time measuring block is configured to stop its measurement when a measured value of the at least one time measuring block has reached a predetermined limit value; and
an evaluation block configured to evaluate the measured value of the at least one time measuring block at an end of the predetermined time to set the transmitting module, based on an evaulation result of the evaluating, for operation in the first communication phase or for operation in the second communication phase.

18. The interface module according to claim 17, wherein the evaluation block is configured to, based on the evaluation result: (i) switch the transmitting module to a first operating mode for the first communication phase for transmission, or (ii) switch the transmitting module to a second operating mode or third operating mode for the second communication phase for transmission.

19. The interface module according to claim 18, wherein the at least one time measuring block includes at least four time measuring blocks, and wherein the evaluation block is configured to evaluate a measured value of each of the at least four time measuring blocks at an end of the predetermined time to decode a pulse-width-modulated symbol of the digital transmission signal by evaluating the measured values of the at least four time measuring blocks in order to output a pulse-width-demodulated transmission signal to the transmitting module.

20. The interface module according to claim 19, further comprising:
a switching block configured to output an oscillating signal for specifying the predetermined timing clock with which all of the time measuring blocks carry out their measurement intermittently.

21. The interface module according to claim 19, wherein:
a first time measuring block of the at least four time measuring blocks is configured to restart the measurement with each edge of the digital transmission signal and to stop the measurement when the measured value of the first time measuring block has reached a predetermined limit value; and
the evaluation block is configured to preselect the second operating mode for the transmitting module for the second communication phase when the measured value of the first time measuring block corresponds to a first predetermined time.

22. The interface module according to claim 21, wherein:
a second time measuring block of the at least four time measuring blocks is configured to start the measurement with each rising edge of the digital transmission signal and to measure until a next rising edge of the digital transmission signal, until the predetermined limit value is exceeded;
a third time measuring block of the at least four time measuring blocks is configured to start the measurement with each falling edge of the digital transmission signal and to measure until the next falling edge of the digital transmission signal, until the predetermined limit value is exceeded; and
wherein the evaluation block is configured to switch the transmitting module to the second operating mode for the second communication phase when the evaluation of the measurement result of the second and third time measuring blocks indicates that, in the digital transmission signal, a distance between a rising edge and a falling edge or the distance between a falling edge and a rising edge is equal to a second predetermined time, which is the bit duration of bits of the second communication phase and which is shorter than the first predetermined time.

23. The interface module according to claim 22, wherein:
a fourth time measuring block of the at least four time measuring blocks is configured to start the measurement with each rising edge of the digital transmission signal and to measure until the next falling edge of the digital transmission signal, until the predetermined limit value is exceeded;
a fifth time measuring block of the at least tour time measuring blocks is configured to start the measurement with each falling edge of the digital transmission signal and to measure until the next rising edge of the digital transmission signal, until the predetermined limit value is exceeded; and
the evaluation block is configured to compare the measurement of the second and fourth time measuring blocks with each other and to compare the measurement of the third and fifth time measuring blocks with each other, and to output the pulse-width-demodulated transmission signal to the transmitting module based on results of the comparisons.

24. The interface module according to claim 19, wherein the at least one time measuring block includes is a counter.

25. The interface module according to claim 24, wherein:
at least two time measuring blocks of the at least one time measuring block are configured to stop counting at a count value which corresponds to a symbol time period for a PWM symbol of a pulse-width-modulated (PWM) signal; and
the evaluation block is configured to evaluate a value of the PWM symbol of the pulse-width-modulated signal at an end of a PWM symbol using the at least one time measuring block and, using a result of the evaluation of the value of the PWM symbol, to output a level for the pulse-width-demodulated transmission signal to the transmitting module.

26. The interface module according to claim 17, wherein:
the at least one time measuring block includes a capacitor having a voltmeter for measuring a voltage across the capacitor;
at least one switchable constant current source is provided as a switching block which is configured to switch the at least one constant current source to charge the capacitor over time;
the at least one time measuring block is configured to stop charging of the at least one capacitor at a predetermined limit voltage value which corresponds to the predetermined time.

27. The interface module according to claim 26, wherein the evaluation block is configured to evaluate a voltage value of the at least one time measuring block.

28. A transmitting/receiving device, comprising:
a transmitting module configure to transmit a digital transmission signal as an analog differential signal onto a bus of a bus system to transmit a message to at least one other subscriber station of the bus system, wherein bits in the digital transmission signal have a longer bit duration in a first communication phase than in a second communication phase of the transmission signal;
a receiving module configured to receive signals from the bus and to generate a digital reception signal from the analog differential signal; and
an interface module including:
at least one time measuring block configured to measure, with a predetermined timing clock, a predetermined time in a digital transmission signal, wherein the at least one time measuring block is configured to stop its measurement when a measured value of the at least one time measuring block has reached a predetermined limit value, and
an evaluation block configured to evaluate the measured value of the at least one time measuring block at an end of the predetermined time to set the transmitting module, based on an evaulation result of the evaluating, for operation in the first communication phase or for operation in the second communication phase.

29. The transmitting/receiving device according to claim 28, wherein the transmitting module is configured to generate the analog differential signals in the first communication phase of the message with a different physical layer than in the second communication phase.

30. A subscriber station for a serial bus system, comprising:
a transmitting/receiving device including:
a transmitting module configure to transmit a digital transmission signal as an analog differential signal onto a bus of a bus system to transmit a message to at least one other subscriber station of the bus system, wherein bits in the digital transmission signal have a longer bit duration in a first communication phase than in a second communication phase of the transmission signal,
a receiving module configured to receive signals from the bus and to generate a digital reception signal from the analog differential signal, and
an interface module including:
at least one time measuring block configured to measure, with a predetermined timing clock, a predetermined time in a digital transmission signal, wherein the at least one time measuring block is configured to stop its measurement when a measured value of the at least one time measuring block has reached a predetermined limit value, and
an evaluation block configured to evaluate the measured value of the at least one time measuring block at an end of the predetermined time to set the transmitting module, based on an evaulation result of the evaluating, for operation in the first communication phase or for operation in the second communication phase; and
a communication control device configured to control communication in the bus system and to generate a digital transmission signal as a basis for a digital pulse-width-modulated transmission signal for the interface module.

31. The subscriber station according to claim 30, wherein the subscriber station is configured for communication in a bus system in which an exclusive, collision-free access of a subscriber station to the bus of the bus system is guaranteed at least temporarily.

32. A method for transmitting differential signals in a serial bus system, wherein the method is carried out using an interface module for a subscriber station of a serial bus system, wherein the subscriber station has a transmitting module and wherein the interface module has at least one time measuring block and an evaluation block, and wherein the method comprises the following steps:
measuring, using the at least one time measuring block and using a predetermined timing clock, a predetermined time in a digital transmission signal, wherein the at least one time measuring block stops its measurement when the at least one time measuring block has reached a predetermined limit value;
evaluating, using the evaluation block, a measurement result of the measuring of the at least one time measuring block at an end of the predetermined time;
setting, based on a result of the evaluating, the transmitting module for operation in the first communication phase or for operation in the second communication phase; and
transmitting, using the transmitting module, a digital pulse-width-demodulated transmission signal as an analog differential signal onto the bus of the bus system to transmit a message to at least one other subscriber station of the bus system, wherein bits in the digital pulse-width-demodulated transmission signal have a longer bit duration in a first communication phase than in a second communication phase of the transmission signal.
